(19) United States
(12) Patent Application Publication
(10) Pub. No.: US 2022/0281212 A1
(43) Pub. Date: Sep. 8, 2022

(54) PACKAGED BINDER UNITS

(71) Applicant: SHELL OIL COMPANY, HOUSTON, TX (US)

(72) Inventors: Subhendu Manindra BHATTACHARYA, Bangalore North, Karnataka (IN); Dawid John D'MELO, Bangalore North, Karnataka (IN); Richard Ernest TAYLOR, London (GB)

(21) Appl. No.: 17/636,518

(22) PCT Filed: Sep. 17, 2020
(86) PCT No.: PCT/EP2020/076043

§ 371 Date: Feb. 18, 2022

(30) Foreign Application Priority Data
Sep. 20, 2019 (IN) 201941038019

(51) Int. Cl. B32B 27/08; B32B 1/00; B32B 27/32; B32B 27/36; B65D 75/26; B65D 85/00; C04B 26/26; C04B 20/12; C04B 20/10; C04B 40/06

(52) U.S. Cl. CPC B32B 27/08; B32B 1/00; B32B 27/32; B32B 27/36; B65D 75/26; B65D 85/70; C04B 26/26; C04B 20/123; C04B 20/1033; C04B 20/1037; C04B 40/0641; B32B 2439/46; B32B 2307/518; B32B 2307/54; B32B 2250/24; B32B 2307/31; C04B 2111/0075

(57) ABSTRACT

The present invention provides a packaged binder unit comprising a binder core retained within a sealable laminated bilayer, wherein the sealable laminated bilayer comprises a bi-axially oriented polymer layer and a non-bi-axially oriented polymer layer, and wherein the binder core comprises a bituminous binder or a synthetic binder.

The present invention further provides a process for manufacturing an asphalt composition comprising the step of mixing the binder unit according to the present invention in a mixing unit with aggregates heated to a temperature in the range of from 140° C. to 220° C.

Additionally, the present invention also provides for a process for manufacturing an asphalt pavement, further comprising spreading the asphalt composition into a layer and compacting the layer, wherein the compaction in step suitably takes place at a temperature of from 120° C. to 180° C.

### FIELD OF THE INVENTION

The invention relates to a packaged binder unit. The invention also relates to the use of a packaged binder unit to manufacture an asphalt composition. The invention further relates to processes for the manufacture of an asphalt composition and an asphalt pavement using a packaged binder unit.

### BACKGROUND OF THE INVENTION

Bitumen is a complex mixture of hydrocarbons, which may occur naturally, or may be a petroleum/crude oil distillation product. Depending on the temperature that it is exposed to, it may be a viscous liquid, or a solid, and it softens gradually when heated. Bitumen may be combined with aggregates and often fillers to provide an asphalt composition that can be used in the manufacture of paved roads. Alternatively, bitumen may be used in industrial applications such as roofing, flooring or sealing.

Synthetic binders, such as Shell's ‘Mexphalte C’™ possess similar rheological and mechanical properties to the bituminous binders typically used in road applications. The synthetic binders are typically clear, so they are readily pigmented and are used to obtain coloured asphalt composition. In this description, the term “binder” covers both bituminous materials and synthetic materials having similar rheological and mechanical properties. The term “asphalt” in the present description is used to describe a mixture of binder and aggregate and/or filler, which may be used for applications that include, but not limited to, manufacturing an asphalt pavement. The activities covered by the phrase “manufacturing an asphalt pavement” includes activities such as, but not limited to, the laying patches or repair materials for remedial works, as well as the manufacture of an asphalt road/pavement.

Bituminous and synthetic binders are typically transported in a heated state to ensure that they are sufficiently fluid for use. However, this is costly in terms of energy usage and requires strict safety procedures. Also, if the binder is stored at elevated temperatures for an extended period, this can lead to changes in the properties of the binder, so storage time is typically limited to avoid degradation in binder properties.

It is desirable to transport and store the binder at ambient temperature, preferably as units of a size and shape that are readily handled. The term “binder unit” as used in the present description encompasses a wide variety of discrete solid entities such as rods, sheets, ‘pillow’ shaped entities, etc.

U.S. Pat. No. 3,366,233 discloses asphalt packaged in multi-layer laminated film bags or wrappers to obviate permeability to oil present in the asphalt, the films being of polyethylene (PE), polypropylene (PP) or a plastomeric or plastic copolymer of ethylene with propylene, the latter comonomer forms between 1-10% of the material and the other the remainder. Various combinations of films and laminates may be used in the same package. The laminated films are secured together by adhesives, such as a petroleum adhesive, which are compatible with the asphalt when the whole package is melted together for use. A plasticizer such as tricresyl phosphate may be incorporated in the asphalt or film to aid the dissolution or solvating of the film in the asphalt at the mixing plant.

U.S. Pat. No. 5,452,800 discloses a packaging for roofing asphalt comprising a single sheet polypropylene film 1.0 to 1.8 mm thick with a melting point between 275° F. (−77° C.) and 335° F. (−104° C.) as the sole containment, and a method for manufacturing the same.

US20180354696 discloses a package comprising an exterior surface comprising oriented-polypropylene (OPP), and an interior surface comprising a PBPE/LDPE (propylene-based plastomer or elastomer/low desity ployethylene) blend, the package further comprising a peelable end seal formed by joining in a heat seal two sections of the interior surface, and a lap seal formed by joining in a heat seal a section of the interior surface with a section of the exterior surface. OPP is mono-oriented cast polypropylene (CPP), or bi-oriented polypropylene (BOPP). The PBPE/LDPE blend comprises at least 50% of a PBPE, and less than 50% of LDPE.

The present inventors have sought to provide packaged binder units to transport binders in a solid state, at least from their manufacturing site to their end-user site, which during packaging and transportation retains the binder without suffering any physical detriment to the packaging, and when added to heated aggregate during the process of manufacturing an asphalt mixture, does not adversely affect the physical, chemical or rheological properties of the binder, nor the properties of the asphalt pavement manufactured from the packaged binder units.

### SUMMARY OF THE INVENTION

Accordingly, the present invention provides a packaged binder unit comprising a binder core retained within a sealable laminated bilayer, wherein the sealable laminated bilayer comprises a bi-axially oriented polymer layer and a non-bi-axially oriented polymer layer, and wherein the binder core comprises a bituminous binder or a synthetic binder.

The present invention also relates to the use of said binder unit to manufacture an asphalt composition.

The present invention further provides a process for manufacturing an asphalt composition comprising the step of mixing the binder unit according to the present invention in a mixing unit with aggregates heated to a temperature in the range of from 140° C. to 220° C.

Additionally, the present invention also provides for a process for manufacturing an asphalt pavement, comprising a step wherein asphalt is prepared by a process according to the invention herein, and further steps comprising spreading the asphalt composition into a layer and compacting the layer, wherein the compaction in step suitably takes place at a temperature of from 120° C. to 180° C.

### BRIEF DESCRIPTION OF THE DRAWINGS

FIG. 1 is a schematic diagram of a perspective view of an embodiment of the packaged binder unit according to the present invention.

FIG. 2 is a schematic diagram of an end view of a transverse section of the packaged binder unit according to the present invention.

FIG. 3 is a graph showing the results of the tests to ascertain how the presence of the sealable laminated bilayer affects the performance of asphalt compositions.

FIG. 4 is a graph showing results of the tests to ascertain how the presence of the sealable laminated bilayer affects the performance of asphalt compositions.

### DETAILED DESCRIPTION OF THE INVENTION

The packaged binder unit of the present invention comprises a binder core retained within a sealable laminated bilayer.

The sealable laminated bilayer comprises a bi-axially oriented polymer layer and a non-bi-axially oriented polymer layer.

Bi-axially oriented polymers are generally manufactured as a polymer film, by stretching or drawing the polymer film in two directions that are perpendicular to each other (otherwise known as the ‘machine direction’ and the ‘transverse direction’) sequentially or simultaneously. The process is well known; however, each manufacturer may have their own specific aspects relating to their stretching/drawing process.

The bi-axial orientation of the polymer film improves the mechanical properties of the film, such as but limited to its seal strength, elongation at break and its tensile strength. Such a process may, for example, increase the tensile strength of the film by about 10-fold.

The sealable laminated bilayer comprises a bi-axially oriented polymer selected from bi-axially oriented polypropylene (“BOPP” hereinafter), or bi-axially oriented polyethylene terephthalate (“BOPET” hereinafter).

BOPP is generally used for the packaging of food and pharmaceuticals, as it has high tensile strength, chemical and physical stability, it is water impermeable and is deemed to be non-toxic.

BOPET is also used for its high tensile strength, chemical and physical stability, transparency, reflectivity, gas and aroma barrier properties, and electrical insulation. BOPET is, for example, marketed under the trade name “MYLAR”™.

The high tensile strength and physical stability of BOPP and BOPET enables them to be manufactured and used as very thin films/layers.

Typically, BOPP sheets, layers or films are manufactured with a variety of standard thicknesses such as about 8 μm, 12 μm, 20 μm, 30 μm or 35 μm, etc. Typically, BOPET sheets, layers or films are manufactured with a variety of standard thicknesses such as about 10 μm, 12 μm, 20 μm, 25 μm, 30 μm and 35 μm, etc.

The sealable laminated bilayer comprises a non-bi-axially oriented polymer layer.

The non-bi-axially oriented polymer is selected from cast polypropylene (“CPP” hereinafter) or low-density polyethylene (“LDPE” hereinafter].

Both CPP and LDPE are thermoplastics, which unlike BOPP and BOPET, can be readily heat sealed to other sheets, layers or films of CPP and/or LDPE.

CPP possesses a higher tear and impact resistance, and better cold temperature performance as compared to BOPP.

Typically, CPP sheets, layers or films are manufactured with a variety of standard thicknesses such as about 8 μm, 12 μm, 20 μm, 25 μm, 30 μm and 35 μm, etc.

Typically, LDPE sheets, layers or films are manufactured with a variety of non-stadardised thicknesses, or a thickness requested by a customer.

Lamination is a well know process of manufacturing a material in a permanent stable of at least two layers, so that the composite material achieves improved properties such as strength and stability. The multiple layers of a laminated article may comprise laminations of the same material, or lamination of different materials. Many different materials can be laminated together, including sheets, layers or films of polymers. When different materials are laminated together, the resultant laminated material is likely to acquire some of the beneficial properties of each of the component materials. Example of laminated material include sheet glass for windowpanes with improved strength and insulation, as well as polymers such as BOPET laminated with thin aluminium sheets for insulation, electronics and for decorative purposes.

Sheet, layers or films of BOPP and BOPET may be laminated with sheets/layers/films of CPP and LDPE. Lamination processes are well known, for example, by the use of a thermal lamination procedure. Additional steps may improve thermal lamination, for example, a process known as ‘corona treatment’. Corona treatment is a surface modification technique that uses a low temperature corona discharge plasma to impart changes in the properties of a surface. The corona plasma is generated by the application of high voltage to an electrode with a sharp tip. The plasma forms at the tip. A linear array of electrodes is often used to create a curtain of corona plasma, and materials such as polymers, cloth or paper may be passed through the corona plasma curtain in order to change the surface energy of the material. The change in the surface energy of the corona treated material enables sheets/layers/films of the same material, or other material(s), to be attached to it, making it a useful step in the process of lamination.

In a first embodiment of the binder unit, the sealable laminated bilayer comprises a BOPP sheet/layer/film laminated to a CPP sheet/layer/film.

In a second embodiment of the binder unit, the sealable laminated bilayer comprises BOPET sheet/layer/film laminated to a LDPE sheet/layer/film.

The packaged binder unit of the present invention comprises a binder core retained within a sealable laminated bilayer.

The present inventors have discovered that the retention of the binder core within the sealable laminated bilayer is best achieved if a sheet/layer/film with high tensile strength is laminated with a sheet/layer/film with high seal strength. The inventors have also discovered that the thermal properties of the sealable laminated bilayer need to be compatible with the end-user application of the packaged binder unit, for example, for the manufacture of asphalt compositions and asphalt pavements.

Further, the inventors have sought to reduce the energy cost of transporting binders from their manufacturing site to their end-use applications and have discovered the need to provide a sealable laminated bilayer which does not require a high temperature, or an additional extensive process to melt and/or rupture, as at high temperatures molten binders are more vulnerable to degradation by oxidation. In any case, asphalt manufacture is typically carried out between 140° C. and 200° C., the higher temperature being generally limited to 200° C. for safety, environmental and energy cost reasons.

Bi-axially oriented polymer sheets/layers/films, such as BOPP and BOPET, display high tensile strength, however, they have low seal strength. Further, they have high melting points, thus making them, as a sole component, unsuitable for retaining binders.

Non-bi-axially oriented polymer sheet/layers/films such as CPP and LDPE, on the other hand, have lower melting points and better seal strengths than bi-axially oriented polymer layers/films, thus making them, as a sole component, unsuitable for retaining binders.

The present inventors have found that laminating a non-bi-axially oriented polymers sheets/layer/film to a bi-axially oriented polymer sheet/layer/film provides the advantage that not only the melting point and the rupture characteristics of the sealable laminated bilayer is configured to be within a temperature range suitable for end user applications such as the manufacture of an asphalt composition, but also the laminated bilayer benefits from a higher seal strength.

As such, in the first embodiment, the laminated properties of BOPP laminated with CPP was particularly suitable, and in the second embodiment, the laminated properties of BOPET laminated with LDPE was particularly suitable.

The tensile strength of BOPP is about 110 MPa, its seal strength is about 30 MPa, and its melting temperature is about 240° C., whereas the tensile strength of CPP is about 75 MPa, its seal strength is about 60 MPa, and its melting temperature is about 160° C.

The tensile strength of BOPET is about 250 MPa, its seal strength is about 15 MPa, and its melting temperature is about 260° C., whereas the tensile strength of LDPE is about 10 MPa, its seal strength is about 25 MPa and its melting temperature is about 90° C.

The tensile strength of the sealable laminated bilayer of any embodiment is preferably at most 300 MPa, more preferably at most 250 MPa, and most preferably at most 200 MPa.

The tensile strength of the sealable laminated bilayer of any embodiment is preferably at least 90 MPa, more preferably at least 100 MPa, and most preferably at least 120 MPa.

The seal strength of the sealable laminated bilayer of any embodiment is preferably at most 70 MPa, more preferably at most 60 MPa, and most preferably at most 55 MPa.

The seal strength of the sealable laminated bilayer of any embodiment is preferably at least 35 MPa, more preferably at least 40 MPa, and most preferably at least 50 MPa.

The temperature at which the sealable laminated bilayer of any embodiment ruptures is preferably at most 210° C., more preferably at most 190° C., and most preferably at most 180° C.

The temperature at which the sealable laminated bilayer of any embodiment ruptures is preferably at least 140° C., more preferably at least 150° C., and most preferably at least 160° C.

The total thickness of the sealable laminated bilayer of the first embodiment that comprises BOPP and CPP is preferably at most 70 μm, more preferably at most 60 μm, and most preferably at most 45 μm.

The total thickness of the sealable laminated bilayer of the first embodiment that comprises BOPP and CPP is preferably at least 20 μm, more preferably at least 25 μm, and most preferably at least 35 μm.

The total thickness of the sealable laminated bilayer of the second embodiment that comprises BOPET and LDPE is preferably at most 45 μm, more preferably at most 42 μm, and most preferably at most 40 μm.

The total thickness of the sealable laminated bilayer of the second embodiment that comprises BOPET and LDPE is preferably at least 22 μm, more preferably at least 30 μm, and most preferably at least 35 μm.

In the first embodiment that comprises BOPP and CPP, the relative proportion of the thicknesses of the BOPP layer to the CPP layer is 1:1; for example, a 30 μm BOPP layer may be laminated to a 30 μm CPP layer, or a 12 μm BOPP layer may be laminated to a 12 μm CPP layer, etc.

In the second embodiment that comprises BOPET and LDPE, the relative proportion of the thicknesses of the BOPET layer to the LDPE layer is approximately 70% to approximately 30%; for example, a 30 μm BOPET layer may be laminated to an approximately 13 μm LDPE layer, or a 25 μm BOPET layer may be laminated to an approximately 11 μm LDPE layer, or a 20 μm BOPET layer may be laminated to an approximately 9 μm LDPE layer, etc.

The packaged binder unit of the present invention comprises a binder core retained within a sealable laminated bilayer. The end view of the transverse cross-section profile of the packaged binder unit of any embodiment is tubular. Herein ‘tubular’ means a pipe-like or a tube-like structure wherein its transverse profile comprises an inner wall facing a hollow internal lumen, and an outer/external wall, diametric to the inner wall, facing the exterior of the pipe/tube. The transvers cross-section profile of the ‘tubular’ structure may be be circular, oval, or any other distorted circular form. The overall shape of the binder unit may be pillow-like.

In one embodiment of the packaged binder unit, the packaged binder unit has a single longitudinal sealed region that runs along the longitudinal axis of the sealable laminated bilayer of the packaged binder unit such that, when sealed, the longitudinal sealed region provides the packaged binder unit its tubular profile. Such seal is effected by heat-sealing of the inner walls of the sealable laminated bilayer that comprises the CPP layer or the LDPE layer.

In another embodiment of the packaged binder unit, the packaged binder unit has two longitudinal sealed regions that run along the longitudinal axis of the sealable laminated bilayer of the packaged binder unit such that, when sealed, these longitudinal sealed regions provide the packaged binder unit its tubular profile. Such seal is effected by heat-sealing of the inner walls of the sealable laminated bilayer that comprises the CPP layer or the LDPE layer.

The embodiment of the packaged binder unit that comprises the BOPP and CPP sealable laminated bilayer, and the embodiment of the packaged binder unit that comprises the BOPET and LDPE sealable laminated bilayer, may have either the single longitudinal sealed region or the two longitudinal sealed regions.

Whether the packaged binder unit has the single longitudinal sealed region or the two longitudinal sealed regions, the continuous transverse profile of the sealable laminated bilayer may be disrupted by an at least one continuous lateral sealed region. Such sealed region enables the sealable laminated bilayer to retain material introduced into its hollow internal lumen. To further retain material introduced into its hollow internal lumen, a second continuous lateral sealed region may be present, such that the introduced material is sealed and trapped between the two continuous sealed regions, thus within the sealable laminated bilayer.

As such, the binder unit comprises at least one continuous lateral sealed region extending across the sealable laminated bilayer, which is formed by, for example, the pinching action of a heated seal jaw, such as one that may be the part of a unit that fills the hollow internal lumen formed by the sealable laminated bilayer with the binder to form the binder core.

The at least one continuous lateral sealed region may be perpendicular to the longitudinal axis of the tubular sealable laminated bilayer of the packaged binder unit, or may be substantially perpendicular at any degree of diagonality to the longitudinal axis of the tubular sealable laminated bilayer, but in any event the at least one continuous lateral sealed region, together with the second continuous lateral sealed region, must enable the retention of the binder core within the sealable laminated bilayer without any leakage.

In the first embodiment of the binder unit, the sealable laminated bilayer comprises a BOPP layer laminated to a CPP layer, wherein the BOPP layer of the sealable laminated bilayer is exposed to the exterior of the binder unit, and the CPP layer of the sealable laminated bilayer is exposed to the binder core (i.e. to the interior lumen of the binder unit).

In the second embodiment of the binder unit, the sealable laminated bilayer comprises BOPET layer laminated to a LDPE layer, wherein the BOPET layer of the sealable laminated bilayer is exposed to the exterior of the binder unit, and the LDPE layer of the sealable laminated bilayer is exposed to the binder core (i.e. to the interior lumen of the binder unit).

Such an orientation of the bi-axillary oriented polymer layer to the non-bi-axillary oriented polymer layer facilitates the sealing of the at least one continuous lateral sealed region(s), the single longitudinal sealed region and the two longitudinal sealed regions.

The packaged binder unit of the present invention comprises a binder core retained within a sealable laminated bilayer. The binder core may be bituminous binder or a synthetic binder. The bituminous binder comprises bitumen. Bitumen may be a by-product of petroleum/crude oil refining, as a natural product, or mixtures thereof. The bitumen may be straight run bitumen, thermally cracked residue or precipitation bitumen, e.g. from propane de-asphalting process. The bituminous binder may also be a blend of more than one bitumen. The bituminous binder may comprise a natural rubber or crumb rubber modified binder, a penetration grade binder, or a binder comprising waxes and/or surfactants.

The bitumen for use herein is preferably a paving grade bitumen suitable for road application having a penetration of, for example, from 9 to 1000 dmm, more preferably of from 15 to 450 dmm (tested at 25° C. according to EN 1426: 1999, revised in March 2007) and a softening point of from 25 to 100° C., more preferably of from 25 to 60° C. (tested according to EN 1427: 1999, revised in March 2007).

The binder core may comprise a synthetic binder. Synthetic binders comprise a resin, an oil and/or optionally a polymer. The synthetic binder may be clear/colourless or may be pigmented. The synthetic binder may have similar rheological and mechanical properties to the bituminous binder.

The binder core, whether comprising a bituminous binder or a synthetic binder, can be used to manufacture an asphalt composition, as well as be used for industrial applications such as roofing, flooring or sealing.

The inventors sought to provide a sealable laminated bilayer that does not adversely affect the properties of the binder core, such as its penetration value, and its ability for make asphalt, and in the case of the asphalt pavement, its resistance to rutting and its resistance to moisture damage.

In particular, the inventors sought to keep the weight % of the sealable laminated bilayer of any embodiment as low as possible, such that its level, as compared to the weight of the binder core is preferably at most 2% wt./wt., more preferably at most 1.5% wt./wt., even more preferably at most 1.25% wt./wt., and most preferably at most 1.1% % wt./wt.

The weight % of the sealable laminated bilayer, as compared to the weight of the binder core is preferably at least 0.3% wt./wt., more preferably at least 0.6% wt./wt., even more preferably at least 0.75% wt./wt., and most preferably at least 0.9% % wt./wt.

The weight of the binder core of any embodiment is preferably at most 350 g, more preferably at most 250 g, even more preferably at most 150 g, and most preferably at most 110 g.

The weight of the binder core of any embodiment is preferably at least 25 g, more preferably at least 50 g, even more preferably at least 75 g, and most preferably at least 95 g.

The inventor found that the total thickness of the sealable laminated bilayer was one factor in keeping the weight % of the sealable laminated bilayer as low as possible as compared to that of the binder core, however, the total thickness of the sealable laminated bilayer is limited by the tensile strength of the sealable laminated bilayer, which is required to retain the binder core without rupturing. Further, in the case of asphalt production, the weight % of the sealable binder units is limited by the industry specification that does not permit more than 1% wt./wt. non-binder material to be present in the binder for an asphalt mix.

When the weight % is provided within such limit, the binder unit can be used directly to manufacture an asphalt composition (i.e can be added directly to hot aggregates as packaged binder unit(s) that contain solid binder), and such asphalt composition can be used for road paving applications to manufacture an asphalt pavement. Direct addition of the packaged binder units with solid binder to hot aggregates provides an energy saving as the binder does not need to be maintained in a liquid state during transportation.

Described herein is also the use of a packaged binder unit to manufacture an asphalt composition.

Described herein is also a process for manufacturing an asphalt composition comprising the step of mixing the binder unit according to present invention in a mixing unit with aggregates at a temperature in the range of from 140° C. to 220° C.

Described herein is also a process for manufacturing an asphalt pavement comprising a step wherein the asphalt composition as described above is prepared, and followed by further steps comprising spreading the asphalt composition into a layer and compacting the said layer, wherein the compaction in step suitably takes place at a temperature of from 120° C. to 180° C.

### DETAILED DESCRIPTION OF THE DRAWINGS

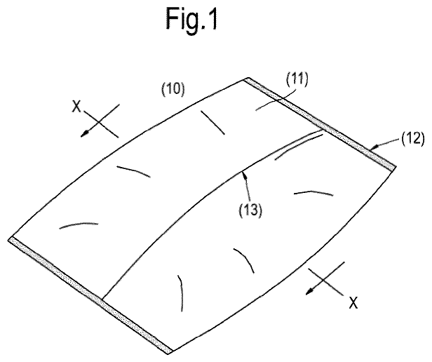

FIG. 1 is a schematic diagram of a perspective view of an embodiment of the packaged binder unit (10) according to the present invention.

The packaged binder unit comprising a binder core (11) retained within a sealable laminated bilayer.

The binder unit comprises at least one continuous lateral sealed region (12) extending substantially transversely across the sealable laminated bilayer of the packaged binder unit.

In the embodiment depicted, the binder unit comprises a single longitudinal sealed region (13) that runs along the longitudinal axis of the sealable laminated bilayer of the packaged binder unit such that, when sealed, the longitudinal sealed region provides the packaged binder unit its tubular profile.

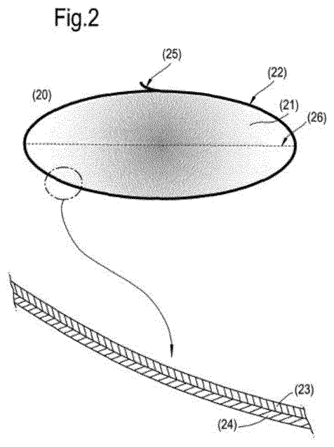

FIG. 2 is a schematic diagram of an end view of a transverse cross-section (along the axis X-X shown in FIG. 1) of an embodiment of the packaged binder unit according to the present invention.

The packaged binder unit comprising a binder core (21) retained within a sealable laminated bilayer (22).

The sealable laminated bilayer comprises a bi-axially oriented polymer layer (24) and a non-bi-axially oriented polymer layer (23).

The binder unit comprises at least one continuous lateral sealed region (26) extending substantially transversely across the sealable laminated bilayer of the packaged binder unit.

In the embodiment depicted, the binder unit comprises a single longitudinal sealed region (25) that runs along the longitudinal axis of the sealable laminated bilayer of the packaged binder unit such that, when sealed, the longitudinal sealed region provides the packaged binder unit its tubular profile.

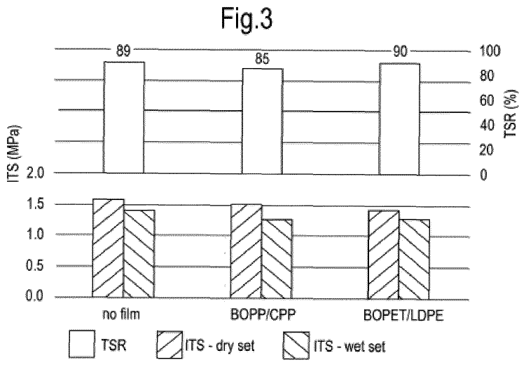

FIG. 3 is a graph showing the results of the tests to ascertain how the presence of the sealable laminated bilayer affects the performance of asphalt compositions. ‘No film’ means no sealable laminated bilayer; ‘ITS’ means indirect tensile strength (force required to break the specimen); and ‘TSR’ means tensile strength ratio (ratio between dry and wet strength).

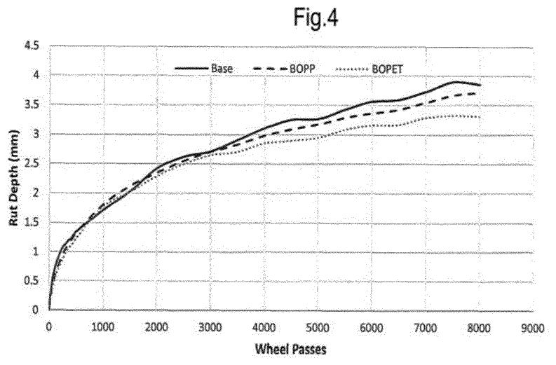

FIG. 4 is a graph of ‘rut depth’ (x axis) versus ‘wheel passes’ (y axis) showing results of the tests to ascertain how the presence of the sealable laminated bilayer affects the performance of asphalt compositions. ‘Bases’ means no sealable laminated bilayer; ‘BOPP’ means the embodiment with the BOPP and CPP sealable laminated bilayer; and ‘BOPET’ means the embodiment with BOPET and LDPE sealable laminated bilayer.

### EXAMPLES

The invention will now be described by reference to examples which are not intended to be limiting of the invention.

### Example 1

Load testing was carried out on packaged binder units containing 95-105 g binder, comprising the sealable laminated binder bilayers according to the present invention, to compare their performance to other packaged binder units comprising a casing made from materials not according to the present invention.

The other casings made from materials not according to the present invention were LDPE only, LDPE/HDPE laminate, LLDPE/HDPE laminate, BOPP only and CPP only.

Load testing was carried out on the packaged binder units comprising BOPP only, CPP only, BOPP/CPP and BOPET/LDPE for 7 days at 60° C. under a load of 2T. However, for the packaged binder units comprising LDPE only, LDPE/HDPE laminate and LLDPE/HDPE laminate, shorter periods at lower temperature and less load was applied, as set out in Table 1 to ascertain the limit of their integrity, as such materials are not as robust as BOPP/CPP and BOPET/LDPE.

The results set out in Table 1 show that packaged binder units with casings made from materials not according to the present invention all ruptured (“X”) (i.e. LDPE only, LDPE/HDPE laminate, LLDPE/HDPE laminate, BOPP only and CPP only), whereas the packaged binder units comprising the sealable laminated binder bilayer according to the present invention remained intact (“Ai”) after such treatment.

TABLE 1

| | Ultimate | | | | | |
|---|---|---|---|---|---|---|
| | tensile | | Seal | | | |
| Polymer film/ | strength | | strength | | | Load test |
| layer type | MD (MPa) | | (MPa) | Test load | | results |
| LDPE | 9-11 | MPa | 25 MPa | 0.2 T | at 25° C. | X |
| LDPE/HDPE | 30-35 | MPa | 18 MPa | 1 T | at 25° C. | X |
| LLDPE/HDPE | 23-25 | MPa | 21 MPa | 1.2 T | at 25° C. | X |
| BOPP | 110 | MPa | 30 MPa | 2 T | at 60° C. | X |
| CPP | 75 | MPa | 60 MPa | 2 T | at 60° C. | X |
| BOPP/CPP | 90 | MPa | 42 MPa | 2 T | at 60° C. | ✓ |
| BOPET/LDPE | 200 | MPa | 35 MPa | 2 T | at 60° C. | ✓ |

### Example 2

Resistance to moisture damage of asphalt compositions were assessed according to the standard test AASHTO T283 to ascertain how the presence of the sealable lamianted bilayer in the asphalt composition affects the performance of asphalt compositions.

The results are set out in FIG. 3 indicate that the stiffness of the asphalt mix, and the effect of moisture on stiffness, is similar for binders with and without the sealable laminated bilayers (BOPP-CPP and BOPET-LDPE).

### Example 3

Resistance to rutting damage of asphalt compositions were assessed according to the standard test AASHTO T340 to ascertain how the presence of the sealable laminated bilayer in the asphalt composition affects the performance of asphalt compositions.

The results are set out in FIG. 4 indicate that the presence of the sealable laminated bilayers (BOPP/CPP and BOPET/LDPE) in the asphalt compositions surprisingly improved resistance to rutting of pavements. The results are depicted in the graph set out in FIG. 4.

We claim:

1. A packaged binder unit (10, 20) comprising a binder core (11, 21) retained within a sealable laminated bilayer (22), wherein the sealable laminated bilayer comprises a bi-axially oriented polymer layer (24) and a non-bi-axially oriented polymer layer (23), and wherein the binder core (11, 21) comprises a bituminous binder or a synthetic binder.

2. The packaged binder unit according to claim 1, wherein the bi-axially oriented polymer layer (24) comprises a bi-axially oriented polymer selected from bi-axially oriented polypropylene or bi-axially oriented polyethylene terephthalate.

3. The packaged binder unit according to claim 1, wherein the non-bi-axially oriented polymer layer (23) comprises a non-bi-axially oriented polymer selected from cast polypropylene or low-density polyethylene.

4. The packaged binder unit according to claim 2, wherein the sealable laminated bilayer (22) comprises a bi-axially oriented polypropylene layer laminated to a cast polypropylene layer.

5. The packaged binder unit according to claim 2, wherein the sealable laminated bilayer (22) comprises a bi-axially oriented polyethylene terephthalate layer laminated to a low-density polyethylene layer.

6. The packaged binder unit according to claim 4, wherein the bi-axially oriented polypropylene of the sealable laminated bilayer is exposed to the exterior of the binder unit, and the cast polypropylene layer of the sealable laminated bilayer is exposed to the binder core.

7. The packaged binder unit according to claim 5 wherein the bi-axially oriented polyethylene terephthalate layer of the sealable laminated bilayer is exposed to the exterior of the binder unit, and the low-density polyethylene layer of the sealable laminated bilayer is exposed to the binder core.

8. The packaged binder unit according to claim 6, wherein the transverse cross-section profile of the packaged binder unit is tubular.

9. The packaged binder unit according to claim 8, wherein the bituminous binder comprises a polymer-modified binder, a natural rubber or crumb rubber modified binder, a penetration grade binder, or a binder comprising waxes and/or surfactants.

10. The packaged binder unit according to claim 8, wherein the synthetic binder comprises a resin, an oil and/or a polymer.

11. The packaged binder unit according to claim 1, wherein binder unit comprises at least one continuous lateral sealed region (12, 26) extending across the sealable laminated bilayer.

12. Use of a packaged binder unit (10, 20) according to claim 1 to manufacture an asphalt composition.

13. A process for manufacturing an asphalt composition comprising the step of mixing the packaged binder unit according to claim 1 in a mixing unit (10, 20) with aggregates at a temperature in the range of from 140° C. to 220° C.

14. A process for manufacturing an asphalt pavement, comprising a step wherein the asphalt composition according to claim 12 is prepared, and further steps comprising spreading the asphalt composition into a layer, and compacting the layer, wherein the compaction in step (ii) takes place at a temperature of from 120° C. to 180° C.
